(19) United States
(12) Patent Application Publication
(10) Pub. No.: US 2025/0242607 A1
(43) Pub. Date: Jul. 31, 2025

(54) MEDIUM TRANSPORT DEVICE AND RECORDING DEVICE

(71) Applicant: SEIKO EPSON CORPORATION, Tokyo (JP)

(72) Inventor: Takeru OGUCHI, CHINO-SHI (JP)

(21) Appl. No.: 19/039,415

(22) Filed: Jan. 28, 2025

(30) Foreign Application Priority Data
Jan. 29, 2024 (JP) 2024010792

(51) Int. Cl. B41J 11/00

(52) U.S. Cl. CPC B41J 11/0015; B41J 11/007; B41J 11/0085

(57) ABSTRACT

A charge applying portion that charges a medium has a rotation portion that is rotated and driven by a drive source. The rotation portion includes needle electrodes and electrodeless portions that are portions in which no needle electrodes are provided. Positions in a width direction of the plurality of needle electrodes disposed in the width direction correspond to positions of suction holes, and positions in the width direction of the electrodeless portions correspond to the positions of the suction holes. As the transport belt and the rotation portion rotate, the needle electrodes face areas between two suction holes located in the transport belt along the transport direction, and the electrodeless portions face the suction holes as the transport belt and the rotation portion rotate.

The present application is based on, and claims priority from JP Application Serial Number 2024-010792, filed Jan. 29, 2024, the disclosure of which is hereby incorporated by reference herein in its entirety.

### BACKGROUNDS

### 1. Technical Field

The present disclosure relates to a medium transport device that transports a medium, and a recording device including the medium transport device.

### 2. Related Art

An inkjet recording device described in JP-A-2016-129983 includes a transport belt, a needle electrode, and a plate-shaped member. The transport belt transports paper while sucking the paper through suction holes. The needle electrode applies a voltage to the paper. The plate-shaped member is disposed between a recording head and the electrode, and a voltage with a polarity opposite to that of the needle electrode is applied. Since paper dust charged to a negative polarity by the needle electrode is adsorbed to the plate-shaped member charged to a positive polarity, the paper dust can be removed from the paper.

In the inkjet recording device described in JP-A-2016-129983, the needle electrodes are disposed at positions facing center positions of suction holes adjacent in a width direction, that is, a position avoiding the suction holes. Since the paper dust is sucked by the suction holes at positions of the suction holes, needle electrodes are disposed at positions facing the center positions of the adjacent suction holes so that the paper dust can be effectively removed.

In the inkjet recording device described in JP-A-2016-129983, the needle electrodes are disposed at positions avoiding the suction holes, but in this configuration, the paper dust is not charged between the two suction holes in a transport direction. Since the paper dust is not sucked by the suction holes between the two suction holes in the transport direction, the paper dust is not removed by either electrostatic adsorption or suction between the two suction holes in the transport direction. To solve this problem, it is preferable to also dispose the needle electrodes at the positions of the suction holes. However, when the needle electrodes are also disposed at the positions of the suction holes, the backup plate supporting the transport belt is easily charged when the suction holes and the needle electrodes face each other. When the backup plate becomes charged, there is concern that this will have adverse effects on the flight of ink. Further, when paper dust is sucked through the suction holes as in the configuration described in JP-A-2016-129983, the backup plate and the paper dust will be charged in the same polarity, and therefore, there is concern that this may have adverse effects on paper dust suction performance.

### SUMMARY

In order to solve the above problem, a medium transport device of the present disclosure includes a transport belt configured to transport a medium by rotating while adsorbing the medium through a plurality of suction holes, a support portion configured to support the transport belt, a charge applying portion configured to charge the medium transported by the transport belt, and a charging portion provided downstream of the charge applying portion in a transport direction of the medium, and configured to be charged with a polarity opposite to a polarity of the medium charged by the charge applying portion, wherein the charge applying portion includes a rotation portion having a rotation axis along a width direction, the width direction intersecting with the transport direction, the rotation portion includes a plurality of needle electrodes disposed around the rotation axis and further disposed along the width direction, and an electrodeless portion, the electrodeless portion being a portion where no needle electrode is provided and a plurality of the electrodeless portions being disposed along the width direction, positions in the width direction of the plurality of needle electrodes disposed along the width direction correspond to positions of the suction holes, positions in the width direction of the plurality of electrodeless portions disposed along the width direction correspond to the positions of the suction holes, the needle electrodes face an area between two of the suction holes located along the transport direction in the transport belt as the transport belt and the rotation portion rotate, and the electrodeless portions face the suction holes as the transport belt and the rotation portion rotate.

Further, the recording device of the present disclosure includes the medium transport device, and a recording unit located downstream of the charging portion in the transport direction and configured to perform recording on the medium.

### BRIEF DESCRIPTION OF THE DRAWINGS

FIG. 1 is a diagram illustrating a medium transport path of a printer.

FIG. 2 is a block diagram illustrating a control system of the printer.

FIG. 3 is a side view of a belt unit, a line head, a charge applying portion, and a charging portion.

FIG. 4 is a side view illustrating a positional relationship between needle electrodes and electrodeless portions and suction holes of the transport belt.

FIG. 5 is a plan view illustrating a positional relationship between the needle electrodes and electrodeless portions and the suction holes of the transport belt.

FIG. 6 is a side view of the belt unit, the line head, the charge applying portion, and the charging portion.

FIG. 7 is a plan view illustrating the positional relationship between the needle electrodes and electrodeless portions and the suction holes of the transport belt.

FIG. 8 is a side view of the belt unit, the line head, the charge applying portion, and the charging portion.

### DESCRIPTION OF EMBODIMENTS

Hereinafter, the present disclosure will be described in brief.

A medium transport device according to a first aspect includes a transport belt configured to transport a medium by rotating while adsorbing the medium through a plurality of suction holes, a support portion configured to support the transport belt, a charge applying portion configured to charge the medium transported by the transport belt, and a charging portion provided downstream of the charge applying portion in a transport direction of the medium, and configured to be charged with a polarity opposite to a polarity of the medium charged by the charge applying portion, wherein the charge applying portion includes a rotation portion having a rotation axis along a width direction, the width direction intersecting with the transport direction, the rotation portion includes a plurality of needle electrodes disposed around the rotation axis and further disposed along the width direction, and an electrodeless portion, the electrodeless portion being a portion where no needle electrode is provided and a plurality of the electrodeless portions being disposed along the width direction, positions in the width direction of the plurality of needle electrodes disposed along the width direction correspond to positions of the suction holes, positions in the width direction of the plurality of electrodeless portions disposed along the width direction correspond to the positions of the suction holes, the needle electrodes face an area between two of the suction holes located along the transport direction in the transport belt as the transport belt and the rotation portion rotate, and the electrodeless portions face the suction holes as the transport belt and the rotation portion rotate.

According to the present aspect, since the needle electrode faces the area between the two suction holes located along the transport direction in the transport belt as the transport belt and the rotation unit rotate, it is possible to also charge the paper dust adhering to the medium between the two suction holes in the transport direction. This makes it possible to remove even paper dust located between the two suction holes in the transport direction.

Since the electrodeless portions face the suction holes as the transport belt and the rotation portion rotate, charging of the support portion by the needle electrode can be curbed, and problems associated with charging of the support portion can be curbed.

A second aspect is an aspect according to the first aspect, wherein a rotation direction of the rotation portion is opposite to a rotation direction of the transport belt. According to the present aspect, since a rotation direction of the rotation portion is opposite to a rotation direction of the transport belt, the needle electrode moves together with the medium in the transport direction when the needle electrode faces the medium. This makes it possible curb damage to the medium even when the medium comes into contact with the needle electrode, and also curb occurrence of jams.

A third aspect is an aspect according to the first aspect, wherein the plurality of suction holes are disposed in a staggered manner in the transport belt, and the electrodeless portions are disposed at positions facing the plurality of suction holes disposed in the staggered manner.

According to the present aspect, since the electrodeless portion is disposed at a position at which the electrodeless portion can face the plurality of suction holes disposed in a staggered manner, charging of the support portion by the needle electrode can be curbed even when the suction holes are disposed in a staggered manner, and problems associated with charging of the support portion can be curbed. This aspect is not limited to the first aspect, and may be subordinate to the second aspect.

A fourth aspect is an aspect according to the first aspect, including a second drive source configured to drive rotation of the transport belt, with a drive source configured to drive rotation of the rotation portion being a first drive source, a first rotation detection unit configured to detect the rotation of the rotation portion, a second rotation detection unit configured to detect the rotation of the transport belt, a first reference detection unit configured to detect a reference position of the rotation of the rotation portion, a second reference detection unit configured to detect a reference position of the rotation of the transport belt, and a control unit configured to control the first drive source and the second drive source so that the suction holes and the electrodeless portions face each other based on detection information of the first rotation detection unit, the second rotation detection unit, the first reference detection unit, and the second reference detection unit.

According to the present aspect, it is possible to reliably cause the suction holes and the electrodeless portions to face each other, using the control unit.

This aspect is not limited to the first aspect, and may be subordinate to the second or third aspect.

A fifth aspect is an aspect according to the first aspect, wherein a drive source configured to drive rotation of the rotation portion also serves as a drive source for the transport belt, and the medium transport device includes a power transmission mechanism configured to synchronize the rotation of the transport belt with the rotation of the rotation portion so that the suction holes and the electrodeless portions face each other.

According to the present aspect, since a drive source configured to drive rotation of the rotation portion also serves as a drive source for the transport belt, an increase in cost of the device can be curbed. Further, since the medium transport device includes a power transmission mechanism configured to synchronize the rotation of the transport belt with the rotation of the rotation portion so that the suction hole and the electrodeless portion face each other, it is possible to reliably cause the suction hole and the electrodeless portion to face each other. This aspect is not limited to the first aspect, and may be subordinate to the second or third aspect.

A sixth aspect is an aspect according to the first aspect, wherein the needle electrode is used as a first needle electrode, the rotation portion includes a plurality of second needle electrodes disposed around the rotation axis, and a position of the second needle electrode in the width direction is in a position avoiding the suction hole.

According to the present aspect, it is possible to charge the paper dust adhering to the medium using the second needle electrode even in an area where there is no suction hole in the width direction. This makes it possible to more reliably remove paper dust. This aspect is not limited to the first aspect, and may be subordinate to any of the second to fifth aspects.

A seventh aspect is an aspect according to the first aspect, including an insulating member configured to surround the rotation portion. According to the present aspect, since the insulating member surrounding the rotation portion is included, charging of other parts by the charge applying portion and adverse effects can be curbed. This aspect is not limited to the first aspect, and may be subordinate to any of the second to sixth aspects.

A recording device according to an eighth aspect includes the medium transport device according to any one of the first to seventh aspects, and a recording unit located downstream of the charging portion in the transport direction and configured to perform recording on the medium. According to the present aspect, in the recording device, the effects of any of the first to seventh aspects described above can be obtained.

A ninth aspect is an aspect according to the eighth aspect, wherein the charge applying portion charges the medium in the same polarity as that of the recording portion. According to the present aspect, since the charge applying portion charges the medium in the same polarity as that of the recording unit, adhesion of paper dust not removed by the charging portion to the recording unit can be curbed.

Hereinafter, the present disclosure will be described in detail. Hereinafter, an inkjet printer 1 that performs recording by ejecting ink, which is an example of a liquid, onto a medium, such as recording paper, will be described as an example of a recording device. Hereinafter, the inkjet printer 1 will be abbreviated as printer 1.

An X-Y-Z coordinate system illustrated in each figure is an orthogonal coordinate system, and a Y-axis direction is a width direction that intersects with a medium transport direction and is also a device depth direction. In the present embodiment, among side surfaces constituting the periphery of a device body 2, the side surface in a +Y direction is a back surface, and the side surface in a −Y direction is a front surface. An X-axis direction is a device width direction, and a +X direction is the left side and an −X direction is the right side as viewed by an operator of the printer 1. Further, the −X direction is a medium feed direction from each medium cassette, which will be described later. The +X direction is the medium transport direction at a position facing a line head 12. A Z-axis direction is a vertical direction, that is, a device height direction, a +Z direction is an upward direction, and a −Z direction is a downward direction.

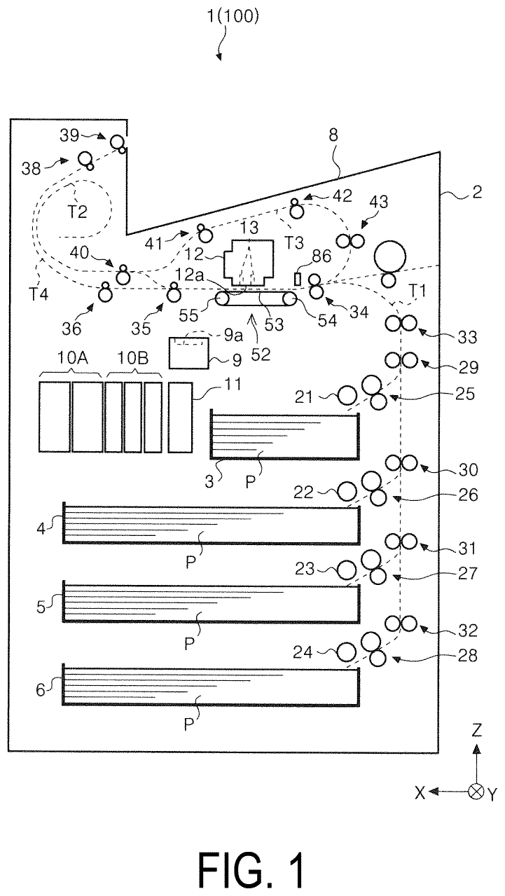

Hereinafter, a direction in which the medium is sent may be referred to as “downstream” and an opposite direction may be referred to as “upstream”. In FIG. 1, the medium transport path is shown by a dashed line. In the printer 1, the medium is transported through the medium transport path shown by the dashed line. The printer 1 may be considered as a medium transport device 100 from the perspective of transporting the medium. In this case, the medium transport device 100 can be considered to have a configuration in which the line head 12 to be described later is not included. In other words, the printer 1 can be considered to be a device including the medium transport device 100 and the line head 12.

The printer 1 includes a plurality of medium cassettes, specifically, a first medium cassette 3, a second medium cassette 4, a third medium cassette 5, and a fourth medium cassette 6 disposed in a vertical direction in a lower portion of the device body 2 including the line head 12 to be described later. A reference sign P denotes a medium accommodated in each medium cassette. A pick roller that feeds the accommodated media in the −X direction is provided for each medium cassette. Reference signs 21, 22, 23, and 24 denote pick rollers provided for the respective medium cassettes. Further, a feed roller pair that feeds the medium sent out by the pick roller further downstream is provided for each medium cassette. Reference signs 25, 26, 27, and 28 denote feed roller pairs provided for the respective medium cassettes. Hereinafter, unless otherwise specified, it is assumed that a “roller pair” includes a drive roller driven by a power source such as a motor, and a driven roller that rotates in a driven manner in contact with the drive roller.

A reference sign T1 denotes a transport path for the medium that is sent out from each medium cassette and reaches the transport roller pair 34. The medium sent out from the first medium cassette 3 receives a feed force from the transport roller pairs 29 and 33 and is sent to the transport roller pair 34. The medium sent out from the second medium cassette 4 receives a feed force from the transport roller pairs 30, 29, and 33 and is sent to the transport roller pair 34. The medium sent out from the third medium cassette 5 receives a feed force from the transport roller pairs 31, 30, 29, and 33 and is sent to the transport roller pair 34. The medium sent out from the fourth medium cassette 6 receives a feed force from the transport roller pairs 32, 31, 30, 29, and 33 and is sent to the transport roller pair 34.

The medium receiving the feed force from the transport roller pair 34 is sent to a recording position between the line head 12 which is an example of a recording unit and the transport belt 53, that is, facing the line head 12. The transport roller pair 34 constitutes a transport portion that transports the medium between the line head 12 and the transport belt 53. The line head 12 performs recording by ejecting ink, which is an example of a liquid, onto a surface of the medium. The line head 12 is an ink ejection head in which a plurality of nozzles 13 that eject ink are disposed to cover the entire area in the width direction of the medium, and is configured as an ink ejection head that can perform recording over the entire width of the medium without moving in the width direction of the medium. However, the ink ejection head is not limited thereto, and may be a type that is mounted on a carriage and ejects ink while moving in the width direction of the medium.

The line head 12 according to the present embodiment employs a piezo element, which is a piezoelectric element whose volume changes when a voltage is applied. A drive waveform of the piezo element is controlled so that a movement of a meniscus of the nozzle 13 can be controlled and a size and ejection speed of ejected ink droplets can be controlled. In the present embodiment, the plurality of nozzles 13 includes a plurality of nozzles 13 that eject yellow ink, a plurality of nozzles 13 that eject magenta ink, a plurality of nozzles 13 that eject cyan ink, and a plurality of nozzles 13 that eject magenta ink.

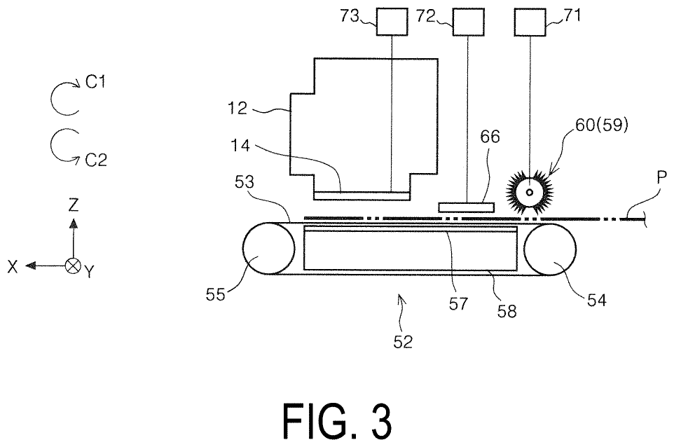

Next, the transport belt 53 is an endless belt that is wound around the first roller 54 and the second roller 55, and rotates when the first roller 54 is driven by a belt drive motor 89 (see FIG. 3). The medium is transported to the position facing the line head 12 while being adsorbed to a belt surface of the transport belt 53. The first roller 54, the second roller 55, and the transport belt 53 constitute a belt unit 52. The belt unit 52 uses the first roller 54 as a rotation axis and is disposed to be rotatable by a power source (not shown).

The medium on which the first side has been recorded by the line head 12 is sent to either the transport roller pair 36 or the transport roller pair 40 by the transport roller pair 35 located downstream of the transport belt 53. A path switching flap (not shown) is provided downstream of the transport roller pair 35, and the medium receiving the feed force from the transport roller pair 35 is sent to any one of the transport roller pair 36 and the transport roller pair 40 by this path switching flap.

When recording is not performed on the second side opposite to the first side of the medium, that is, when double-sided recording is not performed, the medium is sent from the transport roller pair 35 to the transport roller pair 36 and discharged toward the discharge tray 8 through the discharge path T4. The discharge path T4 is provided with the transport roller pair 38 and the transport roller pair 39.

When recording is performed on both the first side and the second side opposite to the first side of the medium, that is, when the double-sided recording is performed, the medium is sent from the transport roller pair 35 to the transport roller pair 40 and enters a switchback path T2. Thereafter, a rotation direction of the transport roller pair 40 is switched, the medium enters a reversal path T3, and is sent to the transport roller pair 34 by the transport roller pairs 41, 42, and 43.

Reference signs 10A and 10B denote ink accommodation portions serving as liquid accommodation portions that accommodate ink before ejection. The ink ejected from the line head 12 is supplied from the ink accommodation portions 10A and 10B to the line head 12 via tubes (not shown). The ink accommodation portion 10A accommodates black ink as an example. The ink accommodation portion 10B accommodates yellow, magenta, and cyan ink as an example.

Reference sign 9 denotes a cap unit including a cap portion 9a that caps the line head 12. The cap unit 9 is provided so that it can be displaced by a power source (not shown) between a separated position (see FIG. 1) where the cap portion 9a is separated from the line head 12 and a cap position (not shown) where the cap portion 9a caps the head surface 12a of the line head 12.

Reference sign 11 denotes a waste liquid storage portion that stores ink as waste liquid ejected from the line head 12 to the cap portion 9a for maintenance. The ink as waste liquid ejected from the line head 12 toward the cap portion 9a for maintenance is sent from the cap portion 9a to the waste liquid storage portion 11 via a tube (not shown).

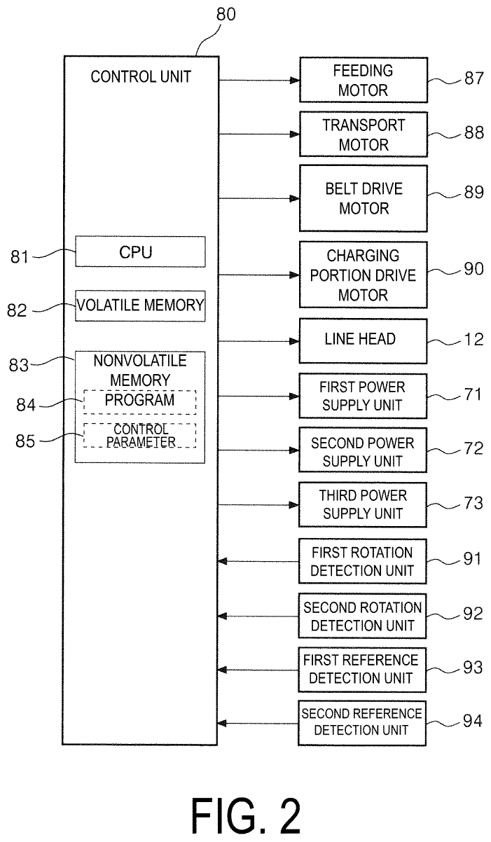

The above is an overview of the overall configuration of the printer 1, and a control unit 80 will be described later with reference to FIG. 2. The control unit 80 performs various controls including recording control in the printer 1. FIG. 2 mainly illustrates a configuration necessary for the following description, and does not illustrate other configurations. A feeding motor 87, a transport motor 88, the belt drive motor 89, a charging portion drive motor 90, the line head 12, a first power supply unit 71, a second power supply unit 72, and a third power supply unit 73 as an output system are electrically coupled to the control unit 80.

The feeding motor 87 is a power source for each pick roller and each feed roller pair described above. Further, the transport motor 88 is a power source for each transport roller pair described above. Further, the belt drive motor 89 is a drive source for the transport belt 53. The charging portion drive motor 90 is a drive source for a rotation portion 60 (see FIG. 3) that constitutes a charge applying portion 59 to be described later. Each motor is a DC motor as an example. The feeding motor 87 and the transport motor 88 are provided with rotary encoders (not shown), and the control unit 80 can detect a rotation direction, rotation amount, and rotation speed of each of the motors using these rotary encoders. That is, the control unit 80 can detect a drive direction, drive amount, and drive speed of each pick roller, each feed roller pair, and each transport roller pair described above.

Further, a first rotation detection unit 91, a second rotation detection unit 92, a first reference detection unit 93, and a second reference detection unit 94 as an input system are electrically coupled to the control unit 80. The first rotation detection unit 91 is a detection unit for detecting the rotation of the rotation portion 60 to be described later, and is a rotary encoder including a rotary scale (not shown) and a detection unit that detects this rotary scale. The rotary scale constituting the first rotation detection unit 91 can be provided in any one of the rotation portion 60, the charging portion drive motor 90, and a gear (not shown) that transmits a driving force from the charging portion drive motor 90 to the rotation portion 60. The second rotation detection unit 92 is a detection unit for detecting the rotation of the transport belt 53, and is a rotary encoder including a rotary scale (not shown) and a detection unit that detects this rotary scale. The rotary scale constituting the second rotation detection unit 92 can be provided in any one of the first roller 54, the second roller 55, the belt drive motor 89, or a gear (not shown) that transmits a driving force from the belt drive motor 89 to the first roller 54.

The first reference detection unit 93 is a detection unit for detecting a reference position of the rotation of the rotation portion 60 to be described later, and can be configured of a rotation flag (not shown) and a detection unit that detects this rotation flag. The rotation flag constituting the first reference detection unit 93 can be provided in any one of the rotation portion 60, the charging portion drive motor 90, or the gear (not shown) that transmits a driving force from the charging portion drive motor 90 to the rotation portion 60. The second reference detection unit 94 is a detection unit for detecting a reference position of the rotation of the transport belt 53, and can include a rotation flag (not shown) and a detection unit that detects this rotation flag. The rotation flag constituting the second reference detection unit 94 can be provided in any one of the first roller 54, the second roller 55, the belt drive motor 89, and the gear (not shown) that transmits a driving force from the belt drive motor 89 to the first roller 54. The control unit 80 can align rotation phases of the transport belt 53 and the rotation portion 60 to be described later, based on detection information of the first rotation detection unit 91, the second rotation detection unit 92, the first reference detection unit 93, and the second reference detection unit 94. In particular, it is possible to cause a suction hole 53a of the transport belt 53 to be described later and an electrodeless portion 60a to be described later to face each other.

Next, the control unit 80 includes a CPU 81 that executes a computer program, in other words, software, a volatile memory 82, and a non-volatile memory 83. The CPU 81 performs various calculations required to execute a program 84 stored in the non-volatile memory 83. The volatile memory 82 is used as a temporary data storage area. The non-volatile memory 83 stores the program 84 and control parameters 85 required to execute the program 84. The program 84 includes a program that executes various processes to be described later, and the control parameters 85 include parameters for executing the program 84. Various processes to be described later are realized by the control unit 80 executing the program 84.

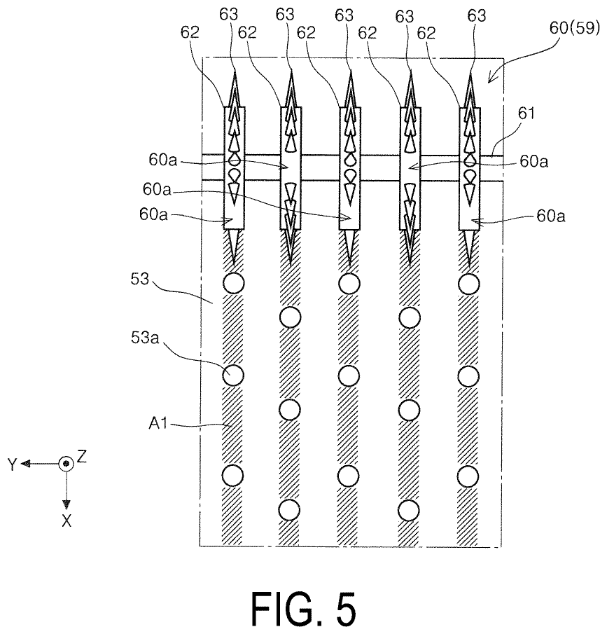

Next, the transport belt 53, the charge applying portion 59, and the charging portion 66 will be described with reference to FIG. 3 and subsequent figures. A plurality of suction holes 53a (see FIG. 5) are formed in the transport belt 53. The plurality of suction holes 53a are formed along the transport direction. The suction holes 53a adjacent along the transport direction are formed at intervals. In the transport belt 53, a plurality of rows in which the plurality of suction holes 53a are disposed side by side along the transport direction are formed along the width direction. In the transport belt 53, the plurality of suction holes 53a are formed in a staggered manner. As illustrated in FIG. 3, a negative pressure chamber 58 and a backup plate 57 which is an example of a support portion that supports the transport belt 53 are provided on the inner side of the transport belt 53. A negative pressure is generated in the negative pressure chamber 58 by a suction fan (not shown), and the negative pressure is applied to the backup plate 57. A hole (not shown) is formed in the backup plate 57, and this is configured so that this hole and the suction hole 53a of the transport belt 53 communicate with each other. Accordingly, the medium on the transport belt 53 is sucked by the suction hole 53a and adsorbed to the transport belt 53. In other words, the transport belt 53 transports the medium by rotating while adsorbing the medium through the plurality of suction holes 53a.

The charge applying portion 59 that charges the medium transported by the transport belt 53 is provided upstream of the line head 12. The charge applying portion 59 is disposed to face the transport belt 53 at a distance so that a gap between the charge applying portion 59 and the medium adsorbed to the transport belt 53 is secured. A voltage is applied to the charge applying portion 59 by the first power supply unit 71. A charging portion 66 is provided downstream of the charge applying portion 59 in the transport direction of the medium. The charging portion 66 is disposed to face the transport belt 53 at a distance so that a gap is formed between the charging portion 66 and the medium transported by the transport belt 53. In the present embodiment, the charging portion 66 is a plate-shaped member that extends in the transport direction and the width direction.

A voltage is applied to the charging portion 66 by the second power supply unit 72. The charging portion 66 is charged to a polarity opposite to the polarity of the medium charged by the charge applying portion 59. When a negative voltage is applied to the charge applying portion 59 by the first power supply unit 71, a positive voltage is applied to the charging portion 66 by the second power supply unit 72. Accordingly, the charge applying portion 59 is negatively charged, and the charging portion 66 is positively charged.

When the charge applying portion 59 is negatively charged, the medium and the paper dust adhered to the medium are negatively charged. The negatively charged paper dust is adsorbed to the positively charged charging portion 66 by a Coulomb force and removed. The charging portion 66 may be formed of a conductor such as metal, or may be formed of an insulator such as resin.

The line head 12 includes a nozzle plate 14 that forms an opening of the nozzle 13, and a voltage is applied to the nozzle plate 14 by the third power supply unit 73. In the present embodiment, when a negative voltage is applied to the charge applying portion 59 by the first power supply unit 71, a negative voltage is applied to the nozzle plate 14 by the third power supply unit 73. This causes the nozzle plate 14 to be negatively charged. In other words, the charge applying portion 59 to be described later charges the medium in the same polarity as the nozzle plate 14 of the line head 12. Since the paper dust adhered to the medium is negatively charged, it is difficult for paper dust of the negatively charged nozzle plate 14 to be adhered. In other words, adhesion of the paper dust not removed by the charging portion 66 to the line head 12 can be curbed. The nozzle plate 14 may be made of a conductor such as metal or may be made of an insulator. The charge polarity of the charge applying portion 59, the charging portion 66, and the nozzle plate 14 may be opposite to that described above.

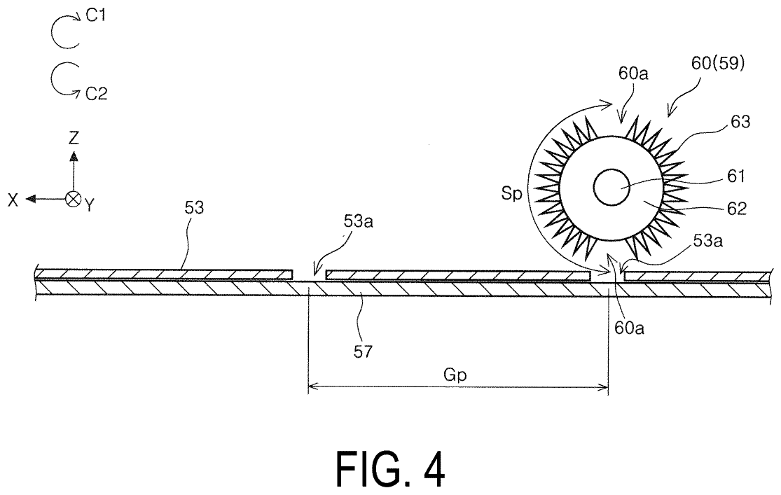

Next, the charge applying portion 59 will be described in detail. The charge applying portion 59 includes the rotation portion 60 having a rotation axis along the Y-axis direction, that is, the width direction, which is a direction intersecting with the medium transport direction. As illustrated in FIGS. 4 and 5, the rotation portion 60 includes a rotation shaft 61 having a rotation axis along the width direction, and a rotation plate 62. A plurality of rotation plates 62 are provided along the width direction with respect to the rotation shaft 61. The rotation plates 62 are fixed to the rotation shaft 61 and rotate together with the rotation shaft 61. Electrical conduction is ensured between the rotation shaft 61 and the rotation plate 62, and a voltage is applied to the rotation shaft 61 by the first power supply unit 71.

A plurality of first needle electrodes 63 are disposed on the rotation plate 62 around a rotation axis of the rotation portion 60. Electrical conduction is ensured between the rotation plate 62 and the first needle electrode 63. Since a plurality of rotation plates 62 are provided along the width direction, the plurality of first needle electrodes 63 are also disposed along the width direction. In the present embodiment, the rotation shaft 61, the rotation plate 62, and the first needle electrode 63 are formed of a conductive material such as metal. In the present embodiment, although the rotation portion 60 is configured by providing the rotation plate 62 including the first needle electrodes 63 along a circumferential direction on the rotation shaft 61, the first needle electrodes 63 may be provided directly on the outer periphery of the rotation shaft 61, for example.

The rotation plate 62 is provided with the electrodeless portion 60a that is a portion in which the first needle electrode 63 is not provided. Since the plurality of rotation plates 62 are provided along the width direction, a plurality of electrodeless portions 60a are also disposed along the width direction. As illustrated in FIG. 5, positions in the width direction of the plurality of first needle electrodes 63 disposed along the width direction correspond to positions of the suction holes 53a. Similarly, a position in the width direction of the electrodeless portion 60a corresponds to the position of the suction hole 53a.

As the transport belt 53 and the rotation portion 60 rotate, the first needle electrodes 63 face an area between the two suction holes 53a located along the transport belt 53 in the transport direction. In FIG. 5, a diagonally hatched area A1 is an area of the transport belt 53 that faces the first needle electrode 63. In the present specification, the first needle electrode 63 or the second needle electrode 65 to be described later faces the transport belt 53 regardless of the presence of a medium between the transport belt 53 and the charge applying portion 59. The electrodeless portion 60a faces the suction hole 53a as the transport belt 53 and the rotation portion 60 rotate. The electrodeless portion 60a faces the backup plate 57 as a support portion through the suction hole 53a as the transport belt 53 and the rotation portion 60 rotate. In the present specification, the electrodeless portion 60a faces the transport belt 53 regardless of the presence of a medium between the transport belt 53 and the charge applying portion 59.

In FIG. 4, a reference sign Gp denotes a distance between the two suction holes 53a in the transport direction. In the present embodiment, the electrodeless portions 60a are provided at two locations in the circumferential direction of the rotation plate 62, and a circumferential distance Sp is equal to the distance Gp between the two suction holes 53a. Therefore, the electrodeless portions 60a provided at the two locations in the circumferential direction of the rotation plate 62 can face the plurality of suction holes 53a located in the transport direction. The control unit 80 controls the belt drive motor 89 and the charging portion drive motor 90 so that the electrodeless portion 60a faces the suction hole 53a.

As described above, the first needle electrode 63 faces the area between the two suction holes 53a located in the transport direction on the transport belt 53 as the transport belt 53 and the rotation portion 60 rotate. Therefore, paper dust adhered to the medium can also be charged between the two suction holes 53a in the transport direction. This makes it possible to also remove paper dust located between the two suction holes 53a in the transport direction. Since the electrodeless portion 60a faces the suction hole 53a as the transport belt 53 and the rotation portion 60 rotate, charging of the backup plate 57 by the first needle electrode 63 can be curbed, and problems associated with the charging of the backup plate 57 can be curbed. Further, since the electrodeless portion 60a is configured to face the suction hole 53a as the rotation portion 60 rotates, noise caused by an operation of the member can be curbed.

Further, in the present embodiment, a rotation direction of the rotation portion 60 is opposite to the rotation direction of the transport belt 53. Specifically, in the present embodiment, the transport belt 53 rotates in a rotation direction C2, and the rotation portion 60 rotates in a rotation direction C1. Accordingly, when the first needle electrode 63 faces the medium, the first needle electrode moves in the transport direction together with the medium. Accordingly, even when the medium comes into contact with the first needle electrode 63, damage to the medium can be curbed and occurrence of jam can be curbed.

In the present embodiment, as illustrated in FIG. 4, the suction holes 53a are disposed in a staggered manner in the transport belt 53. The electrodeless portion 60a is disposed at a position that can face the suction holes 53a disposed in a staggered manner. Specifically, as illustrated in FIG. 5, the plurality of rotation plates 62 disposed in the width direction are disposed so that the positions of the electrodeless portions 60a are shifted alternately, so that the electrodeless portions 60a can face the suction holes 53a disposed in a staggered manner. Even when the suction holes 53a are disposed in a staggered manner in this way, charging of the backup plate 57 by the first needle electrode 63 can be curbed, and problems associated with the charging of the backup plate 57 can be curbed.

In the present embodiment, a second drive source that drives rotation of the transport belt 53 is included, with a drive source that drives the rotation portion 60 being the first drive source. In the present embodiment, the first drive source is the charging portion drive motor 90, and the second drive source is the belt drive motor 89. The control unit 80 controls the charging portion drive motor 90 and the belt drive motor 89 so that the suction hole 53a and the electrodeless portion 60a face each other, based on the detection information of the first rotation detection unit 91, the second rotation detection unit 92, the first reference detection unit 93, and the second reference detection unit 94. With this configuration, it is possible to cause the suction hole 53a and the electrodeless portion 60a to reliably face each other.

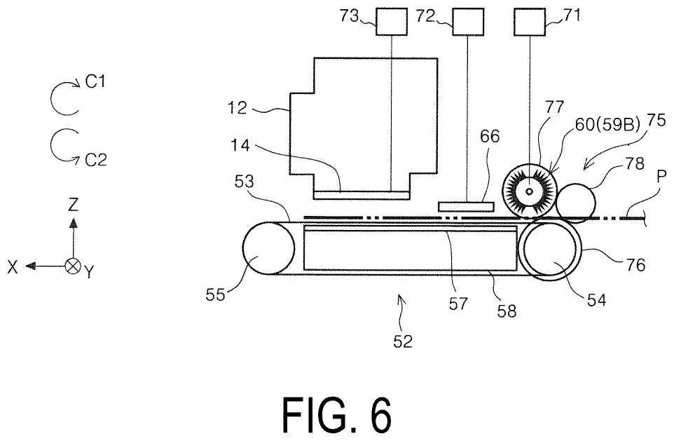

A drive source of the rotation portion 60 may also serve as a drive source of the transport belt 53. FIG. 6 shows such an embodiment, and the present embodiment includes a power transmission mechanism 75. The power transmission mechanism 75 includes a gear 76 that rotates coaxially with the first roller 54, a gear 77 that rotates coaxially with the rotation portion 60, and a gear 78 that meshes with both the gear 76 and the gear 77. As a result, the drive force is transmitted from the gear 77 to the gear 76 via the gear 78, and the transport belt 53 rotates together with the rotation portion 60. The power transmission mechanism 75 synchronizes the rotation of the transport belt 53 with the rotation of the rotation portion 60 so that the suction holes 53a and the electrodeless portion 60a face each other. With this configuration, an increase in cost of the device can be curbed. Further, it is possible to cause the suction holes 53a and the electrodeless portion 60a to reliably face each other using the power transmission mechanism 75 that synchronizes the rotation of the transport belt 53 with the rotation of the rotation portion 60 so that the suction holes 53a and the electrodeless portion 60a face each other.

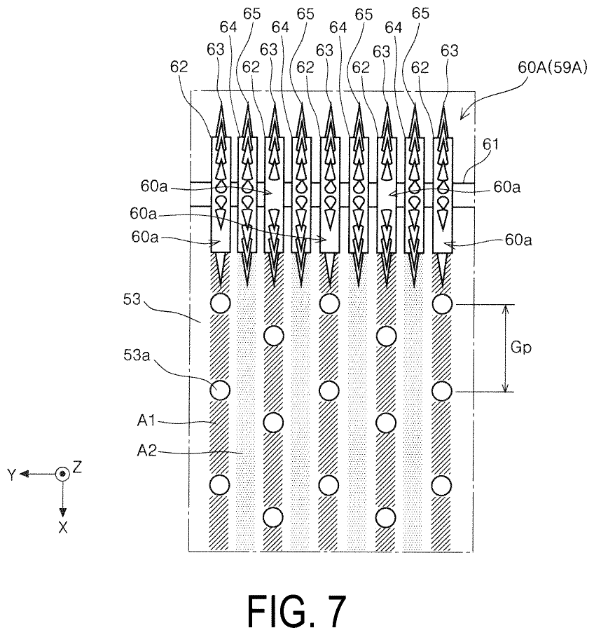

In another embodiment, the rotation portion may be provided with a plurality of second needle electrodes disposed around the rotation axis. FIG. 7 shows a charge applying portion 59A according to another embodiment, and reference sign 60A denotes a rotation portion according to the other embodiment. The rotation portion 60A includes a rotation plate 62 including a first needle electrode 63 and a rotation plate 64 including a second needle electrode 65. The rotation plate 64 has the same configuration as the rotation plate 62, but differs from the rotation plate 62 in that the rotation plate 64 does not include an electrodeless portion 60a. That is, the second needle electrode 65 is provided around the entire circumference in the rotation plate 64. A position of the second needle electrode 65 in the width direction is at a position avoiding the suction holes 53a. In FIG. 7, a dot-hatched area A2 is an area that avoids the suction holes 53a in the width direction, and the second needle electrode 65 faces this area. That is, this is located between rows in which the plurality of suction holes 53a are arranged side by side in the transport direction, which are adjacent along the width direction. With this configuration, it is possible to charge paper dust adhered to the medium with the second needle electrode 65 even in areas where there are no suction holes 53a in the width direction. This makes it possible to more reliably remove paper dust.

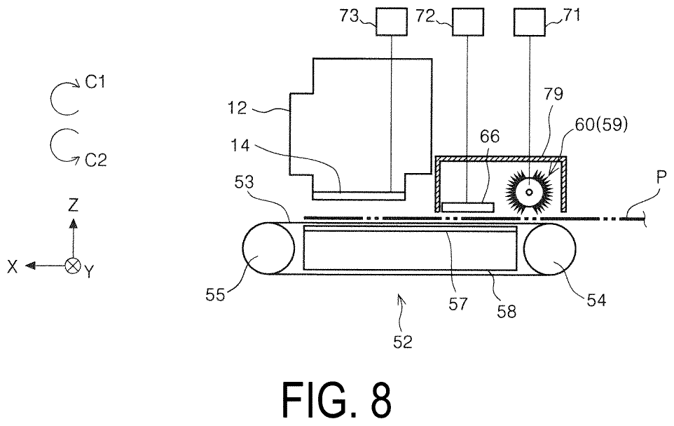

Further, in another embodiment, an insulating member that surrounds the rotation portion 60 may be provided as illustrated in FIG. 8. The insulating member 79 is made of an insulating material and is a box-shaped member with only a portion facing the transport belt 53 open. Providing such an insulating member 79 can curb charging of another part by the charge applying portion 59 and resultant occurrence of adverse effects. In the present embodiment, the insulating member 79 surrounds the charging portion 66 together with the charge applying portion 59. This can curb charging of another part by the charging portion 66 and occurrence of adverse effects. However, the insulating member 79 may not surround the charging portion 66, but may surround only the charge applying portion 59.

Further, it is preferable to configure the device so that a shortest distance between the charge applying portion 59 and the transport belt 53 is shorter than a shortest distance between the charge applying portion 59 and another constituent part. This can curb charging of another part by the charge applying portion 59 and occurrence of adverse effects.

The charging portion 66 described above may be configured of a part of a head support member (not shown) that supports the line head 12. For example, the part of the head support member is configured to protrude toward the transport belt 53, and a voltage is applied to the part so that the part can be used as the charging portion. Further, the charging portion 66 is not limited to a plate-shaped member, and may be configured of a rotation belt. When a voltage is applied to such a belt, paper dust can be adsorbed to the belt. Further, in such a configuration, it is possible to collect the adhered paper dust when a cleaning mechanism such as a wiper is provided in a part of the belt.

The present disclosure is not limited to the embodiments and modifications described above, and it is obvious that various modifications are possible within the scope of the disclosure described in the claims, and these are also included in the scope of the present disclosure.

What is claimed is:

1. A medium transport device comprising:
a transport belt configured to transport a medium by rotating while adsorbing the medium through a plurality of suction holes;
a support portion configured to support the transport belt;
a charge applying portion configured to charge the medium transported by the transport belt; and
a charging portion provided downstream of the charge applying portion in a transport direction of the medium, and configured to be charged with a polarity opposite to a polarity of the medium charged by the charge applying portion, wherein
the charge applying portion includes a rotation portion having a rotation axis along a width direction, the width direction intersecting with the transport direction,
the rotation portion includes
a plurality of needle electrodes disposed around the rotation axis and further disposed along the width direction, and
an electrodeless portion, the electrodeless portion being a portion where no needle electrode is provided and a plurality of the electrodeless portions being disposed along the width direction,
positions in the width direction of the plurality of needle electrodes disposed along the width direction correspond to positions of the suction holes,
positions in the width direction of the plurality of electrodeless portions disposed along the width direction correspond to the positions of the suction holes,
the needle electrodes face an area between two of the suction holes located along the transport direction in the transport belt as the transport belt and the rotation portion rotate, and
the electrodeless portions face the suction holes as the transport belt and the rotation portion rotate.

2. The medium transport device according to claim 1, wherein
a rotation direction of the rotation portion is opposite to a rotation direction of the transport belt.

3. The medium transport device according to claim 1, wherein
the plurality of suction holes are disposed in a staggered manner in the transport belt, and
the electrodeless portions are disposed at positions facing the plurality of suction holes disposed in the staggered manner.

4. The medium transport device according to claim 1, comprising:
a second drive source configured to drive rotation of the transport belt, with a drive source configured to drive rotation of the rotation portion being a first drive source,
a first rotation detection unit configured to detect the rotation of the rotation portion,
a second rotation detection unit configured to detect the rotation of the transport belt,
a first reference detection unit configured to detect a reference position of the rotation of the rotation portion,
a second reference detection unit configured to detect a reference position of the rotation of the transport belt, and
a control unit configured to control the first drive source and the second drive source so that the suction holes and the electrodeless portions face each other based on detection information of the first rotation detection unit, the second rotation detection unit, the first reference detection unit, and the second reference detection unit.

5. The medium transport device according to claim 1, wherein
a drive source configured to drive rotation of the rotation portion also serves as a drive source for the transport belt,
and the medium transport device comprises a power transmission mechanism configured to synchronize the rotation of the transport belt with the rotation of the rotation portion so that the suction hole and the electrodeless portion face each other.

6. The medium transport device according to claim 1, wherein
the needle electrode is used as a first needle electrode, the rotation portion includes a plurality of second needle electrodes disposed around the rotation axis, and
a position of the second needle electrode in the width direction is in a position avoiding the suction hole.

7. The medium transport device according to claim 1, comprising:
an insulating member configured to surround the rotation portion.

8. A recording device comprising:
the medium transport device according to claim 1, and
a recording unit located downstream of the charging portion in the transport direction and configured to perform recording on the medium.

9. The recording device according to claim 8, wherein
the charge applying portion charges the medium in the same polarity as that of the recording portion.
